(19) United States
(12) Patent Application Publication
(10) Pub. No.: US 2022/0239133 A1
(43) Pub. Date: Jul. 28, 2022

(54) CHARGING CIRCUIT AND ADAPTER

(71) Applicant: Nanning FuLian FuGui Precision Industrial Co., Ltd., Nanning (CN)

(72) Inventor: CHONG XU, Shanghai (CN)

(21) Appl. No.: 17/579,319

(22) Filed: Jan. 19, 2022

(30) Foreign Application Priority Data
Jan. 25, 2021 (CN) 202110098703.2

(51) Int. Cl. H02J 7/00

(52) U.S. Cl. CPC H02J 7/0068; H02J 7/0032; H02J 7/00712

(57) ABSTRACT

A charging circuit, comprising: a first interface, configured to connect to an external power source; a charging unit, configured to connected to an external load, wherein the external power source charges the external load through the charging unit; a control unit, electrically connected to the first interface and the charging unit, and configured to output a first control signal when the external power source is activated, and output a second control signal when the external power source stops charging the external load; a load switch, electrically connected to the first interface, the control unit, and the charging unit, and when the first control signal is received, the load switch is turned on, then the external power source charges the external load; when the second control signal is received, the load switch is turned off to prevent voltage from being recharged to the first interface through the charging unit.

### CROSS-REFERENCE TO RELATED APPLICATIONS

This application claims priority to Chinese Patent Application No. 202110098703.2 filed on Jan. 25, 2021, the contents of which are incorporated by reference herein.

### FIELD

The subject matter herein generally relates to the field of charging, and particularly to a charging circuit and an adapter.

### BACKGROUND

Use the charging interface, such as the USB Type-A interface to charge the super capacitor or battery. Because of the extremely low internal resistance of the super capacitor/battery, the output voltage will continue to exist when the power input to the charging interface is turned off. However, usually the charging IC does not have the function of blocking the reverse voltage, so when the power is turned off, the output voltage will be recharged to the input end through the charging IC, causing the input system to malfunction.

### BRIEF DESCRIPTION OF THE DRAWINGS

Implementations of the present technology will now be described, by way of example only, with reference to the attached figures.

FIG. 1 is a schematic diagram of a module of an embodiment of the charging circuit of the present invention.

FIG. 2 is a schematic circuit diagram of an embodiment of the charging circuit of the present invention.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

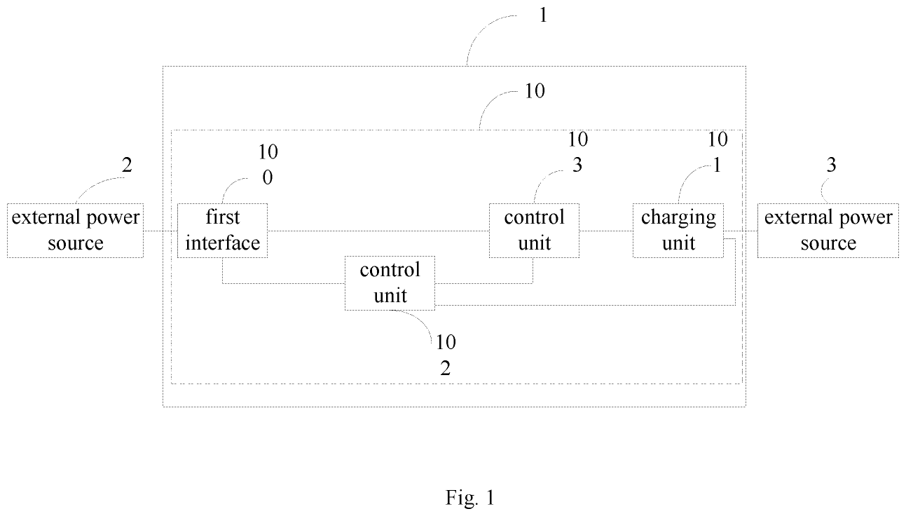

FIG. 1 is a schematic diagram of a module of an embodiment of the charging circuit of the present invention. The adapter 1 includes a charging circuit 10, and the adapter 1 is used to connect to an external power source 2 and an external load 3 to charge the external load 3 through the external power source 2. In the embodiment, the charging circuit 10 includes a first interface 100, a charging unit 101, a control unit 102, a load switch 103, and a charging unit 104.

In the embodiment, the first interface 100 is configured to connect to the external power source 2. Specifically, the first interface 100 may be but is not limited to a USB Type A interface. The charging unit 101 is configured to connect to the external load 3, and the external power source 2 charges the external load 3 through the charging unit 101. The control unit 102 is electrically connected to the first interface 100, the load switch 103 and the charging unit 101, and is configured to output a first control signal when the external power source 2 is activated, and when the external power source 2 stops charging the external load 3, the second control signal is output. The load switch 103 is electrically connected to the first interface 100, the control unit 102, and the charging unit 101, and is configured to turn on the load switch 103 when the first control signal is received, and the external power source 2 charges the external load 3; when the second control signal is received, the load switch 103 is turned off to prevent the voltage from being recharged to the first interface 100 through the charging unit 101, so as to overcome the defect in the prior art that when the external power source 2 is turned off, the output voltage will be recharging to the input through the charging unit.

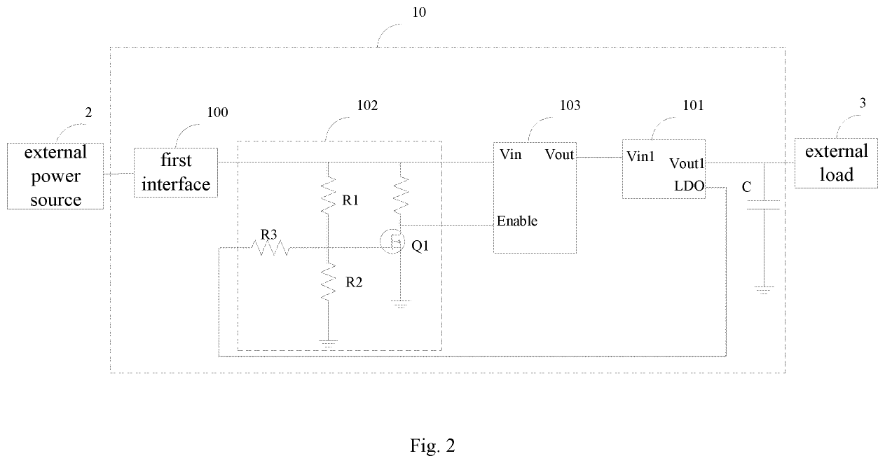

Refer to FIG. 2, which is a schematic circuit diagram of the charging circuit 10 of the present invention. In the embodiment, the control unit 102 includes a first resistor R1, a second resistor R2, a third resistor R3, a fourth resistor R4 and a first electronic switch Q1. One end of the first resistor R1 is electrically connected to a common end of the first interface 100 and the load switch 103. One end of the second resistor R2 is electrically connected to the other end of the first resistor R1, and the other end of the second resistor R2 is grounded. One end of the third resistor R3 is electrically connected to the common end of the first resistor R1 and the second resistor R2, and the other end of the third resistor R3 is electrically connected to the charging unit 102. One end of the fourth resistor R4 is electrically connected to the common end of the first interface 100 and the load switch 103. The first electronic switch Q1 includes a control end, a first end and a second end, and the control end is electrically connected to a common end of the resistor R1 and the second resistor R2, the first end is electrically connected to the other end of the fourth resistor R4 and the load switch 103, and the second end is grounded. In a specific embodiment of the present invention, the first electronic switch Q1 may be an N-type MOS transistor, the gate of the N-type MOS transistor is electrically connected to the common terminal of the first resistor R1 and the second resistor R2, and the drain the N-type MOS transistor is electrically connected to the load switch 103 and the other end of the fourth resistor R4, the source of the N-type MOS transistor is grounded.

In the embodiment, the load switch 103 includes: an input end Vin, an enable terminal and an output end Vout. The input end Vin is electrically connected to the first interface 100. The enable end Enable is electrically connected to the common end of the first electronic switch Q1 and the fourth resistor R4, wherein the enable end Enable is active at low level. When the enable end Enable receives a low level signal, the load switch 103 is turned on; when the enable end Enable receives a high level signal, the load switch 103 is turned off; the output end Vout is electrically connected to the charging unit 101.

In the embodiment, the charging unit 101 is a charging chip, and the charging chip includes: an input end Vin1, and LDO output end and an output end Vout1. The input end Vin1 is electrically connected to the output end Vout of the load switch 103; the LDO output end is electrically connected to the other end of the third resistor R3. When the external power source 2 is activated, the LDO output end outputs the first voltage signal. The output end Vout1 is electrically connected to the external load 3.

Specifically, when the external power source 2 charges the external load 3, a large capacitor C is formed between the charging unit 101 and the external load 3 to store charges, that is, a large capacitor is formed between the output end Vout1 of the charging chip and the external load 3. When the external power source 2 starts, the LDO output end of the charging unit 101 outputs the first voltage signal to the control end of the first electronic switch Q1 through the third resistor R3, and the first electronic switch Q1 is turned on to output the first electronic switch Q1. A control signal is sent to the enable end Enable of the load switch 103, so that the load switch 103 is turned on, and the external power source 2 charges the external load 3 through the charging chip. When the external power source 2 stops charging, the first voltage signal becomes 0, the first electronic switch Q1 is turned off, and the first electronic switch Q1 outputs the second control signal to the enable end Enable of the load switch 103, so that the load switch 103 is turned off to prevent the voltage of the large capacitor from being recharged to the first interface 100, thereby overcoming the defect in the prior art that the output voltage is recharged to the input end through the charging unit when the external power source 2 is turned off.

In the embodiment, when the external power source 2 is activated, the current flowing through the first resistor R1 is the sum of the current flowing through the second resistor R2 and the third resistor R3. When the external power source 2 charges the external load 3, the current flowing through the second resistor R2 is the sum of the current flowing through the first resistor R1 and the third resistor R3. When the external power source 2 stops charging, the current flowing through the first resistor R1 is the sum of the current flowing through the second resistor R2 and the third resistor R3.

Compared with the prior art, in the charging circuit provided by the embodiment of the present invention, the control unit outputs a first control signal when the external power source is activated, and outputs a second control signal when the external power source stops charging the external load, and then the load switch is turned on when receiving the first control signal, and the external power source charges the external load. The load switch is turned off when receiving the second control signal, thereby preventing the voltage from being recharged to the first interface through the charging unit.

Many details are often found in the art such as the other features of a mobile terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A charging circuit, comprising:
a first interface, configured to connect to an external power source;
a charging unit, configured to connect to an external load, wherein the external power source charges the external load through the charging unit;
a control unit, electrically connected to the first interface and the charging unit, and configured to output a first control signal when the external power source is activated, and output a second control signal when the external power source stops charging the external load;
a load switch, electrically connected to the first interface, the control unit, and the charging unit, and when the first control signal is received, the load switch is turned on, then the external power source charges the external load; when the second control signal is received, the load switch is turned off to prevent voltage from being recharged to the first interface through the charging unit.

2. The charging circuit of claim 1, wherein the control unit comprises:
a first resistor, one end electrically connected to a common end of the first interface and the load switch;
a second resistor, one end electrically connected to the other end of the first resistor, and the other end grounded;
a third resistor, one end electrically connected to a common end of the first resistor and the second resistor, and the other end electrically connected to the charging unit;
a fourth resistor, one end electrically connected to a common end of the first interface and the load switch;
a first electronic switch, comprising a control end, a first end, and a second end, and the control terminal is electrically connected to the common end of the first resistor and the second resistor, and the first end is electrically connected to the load switch and the other end of the fourth resistor, and the second end is grounded.

3. The charging circuit of claim 2, wherein the load switch comprises:
an input end, electrically connected to the first interface;
an enable end, electrically connected to a common terminal of the first electronic switch and the fourth resistor;
an output terminal, electrically connected to the charging unit.

4. The charging circuit of claim 3, wherein the charging unit is a charging chip, and the charging chip comprises:
an input end, electrically connected to the output end of the load switch;
a LDO output end, electrically connected to the other end of the third resistor, and when the external power source is activated, the LDO output end outputs a first voltage signal;
an output end, connected to the external load.

5. The charging circuit of claim 4, wherein when the external power source charges the external load, a large capacitance is formed between the charging unit and the external load to store charges.

6. The charging circuit of claim 5, wherein when the external power source is activated, the LDO output end of the charging unit outputs the first voltage signal to the control end of the first electronic switch through the third resistor, and the first electronic switch is turned on to output the first control signal to the enable end of the load switch, so that the load switch is turned on, and the external power source charges the external load through the charging chip;
when the external power source stops charging, the first voltage signal is 0, the first electronic switch is turned off, and the first electronic switch outputs the second control signal to the enable end of the load switch, so that the load switch is turned off to prevent the voltage of the large capacitor from being recharged to the first interface.

7. The charging circuit of claim 6, wherein when the external power source is activated, the current flowing through the first resistor is the sum of the current flowing through the second resistor and the third resistor;
when the external power source charges the external load, the current flowing through the second resistor is the sum of the current flowing through the first resistor and the third resistor;
when the external power source stops charging, the current flowing through the first resistor is the sum of the current flowing through the second resistor and the third resistor.

8. An adapter, comprising a charging circuit, wherein the charging circuit comprises:
a first interface, configured to connect to an external power source;
a charging unit, configured to connect to an external load, wherein the external power source charges the external load through the charging unit;
a control unit, electrically connected to the first interface and the charging unit, and configured to output a first control signal when the external power source is activated, and output a second control signal when the external power source stops charging the external load;
a load switch, electrically connected to the first interface, the control unit, and the charging unit, and when the first control signal is received, the load switch is turned on, then the external power source charges the external load; when the second control signal is received, the load switch is turned off to prevent voltage from being recharged to the first interface through the charging unit.

9. The adapter of claim 8, wherein the control unit comprises:
a first resistor, one end electrically connected to a common end of the first interface and the load switch;
a second resistor, one end electrically connected to the other end of the first resistor, and the other end grounded;
a third resistor, one end electrically connected to a common end of the first resistor and the second resistor, and the other end electrically connected to the charging unit;
a fourth resistor, one end electrically connected to a common end of the first interface and the load switch;
a first electronic switch, comprising a control end, a first end, and a second end, and the control terminal is electrically connected to the common end of the first resistor and the second resistor, and the first end is electrically connected to the load switch and the other end of the fourth resistor, and the second end is grounded.

10. The adapter of claim 9, wherein the load switch comprises:
an input end, electrically connected to the first interface;
an enable end, electrically connected to a common terminal of the first electronic switch and the fourth resistor;
an output terminal, electrically connected to the charging unit.

11. The adapter of claim 10, wherein the charging unit is a charging chip, and the charging chip comprises:
an input end, electrically connected to the output end of the load switch;
a LDO output end, electrically connected to the other end of the third resistor, and when the external power source is activated, the LDO output end outputs a first voltage signal;
an output end, connected to the external load.

12. The adapter of claim 11, wherein when the external power source charges the external load, a large capacitance is formed between the charging unit and the external load to store charges.

13. The adapter of claim 12, wherein when the external power source is activated, the LDO output end of the charging unit outputs the first voltage signal to the control end of the first electronic switch through the third resistor, and the first electronic switch is turned on to output the first control signal to the enable end of the load switch, so that the load switch is turned on, and the external power source charges the external load through the charging chip;
when the external power source stops charging, the first voltage signal is 0, the first electronic switch is turned off, and the first electronic switch outputs the second control signal to the enable end of the load switch, so that the load switch is turned off to prevent the voltage of the large capacitor from being recharged to the first interface.

14. The adapter of claim 13, wherein when the external power source is activated, the current flowing through the first resistor is the sum of the current flowing through the second resistor and the third resistor;
when the external power source charges the external load, the current flowing through the second resistor is the sum of the current flowing through the first resistor and the third resistor;
when the external power source stops charging, the current flowing through the first resistor is the sum of the current flowing through the second resistor and the third resistor.
